(19) United States
(12) Patent Application Publication
(10) Pub. No.: US 2015/0306801 A1
(43) Pub. Date: Oct. 29, 2015

(54) TWO-COLOR MOLDING METHOD, TWO-COLOR MOLDING DIE AND TWO-COLOR MOLDED ARTICLE

(71) Applicant: Koito Manufacturing Co., Ltd., Tokyo (JP)

(72) Inventors: Hiroya Ito, Shizuoka (JP); Akinori Yamamoto, Shizuoka (JP)

(21) Appl. No.: 14/688,236

(22) Filed: Apr. 16, 2015

(30) Foreign Application Priority Data
Apr. 23, 2014 (JP) 2014-089121

(51) Int. Cl. B29C 45/16; B32B 3/26; B29C 45/14

(52) U.S. Cl. CPC B29C 45/16; B29C 45/14065; B32B 3/266; B29K 2995/0026; B29K 2101/00

(57) ABSTRACT

Provided are a two-color molding method, a two-color molding die, and a two-color molded article capable of suppressing deterioration of the appearance quality which is caused by resin shrinkage or resin deformation in a first resin portion in the two-color molding. The method includes molding a first resin portion by a common die and a primary die; and molding a second resin portion by the common die and a secondary die integrally with the first resin portion, in which a shape of the first resin portion is maintained by a holder provided in the secondary die in the molding of the second resin portion. Even when the molded first resin portion is deformed, the shape of the first resin portion is maintained by the holder. Accordingly, deterioration of an appearance quality of the two-color molded article, which is caused by a shape deformation of the first resin portion, is suppressed.

### CROSS-REFERENCE TO RELATED APPLICATIONS

This application is based on and claims priority from Japanese Patent Application No. 2014-089121, filed on Apr. 23, 2014, with the Japan Patent Office, the disclosure of which is incorporated herein in its entirety by reference.

### TECHNICAL FIELD

The disclosure relates to a so-called two-color molding technique of integrally molding different resins, and particularly to a two-color molding method and a two-color molding die suitable for manufacturing a light transmitting body which is one of components of a lamp, and a two-color molded article molded by the two-color molding method and die.

### BACKGROUND

In a lamp, such as, for example, a headlamp of a vehicle, a front cover of a lamp housing accommodating a lamp unit is made of a light transmitting resin, and light emitted from the lamp unit is transmitted through the front cover to illuminate the front area of the vehicle in a required light distribution. In the front cover, an effective portion, that is, a region through which the light is transmitted, is molded of a light transmitting resin only. However, an ineffective portion which does not contribute to the light distribution is molded of a colored non-light transmitting resin so that the inside of the lamp housing is optically shielded. Thus, a part of the inside of the lamp is not visible from the outside to improve the beauty of the external appearance. In many cases, such a front cover is molded by a two-color molding method using a light transmitting resin and a non-light transmitting resin as disclosed in Japanese Patent Laid-Open Publication No. 2011-187299.

In the two-color molding method, a cavity is formed using a common die and a primary die, and a first resin is injected into the cavity to mold a first resin portion. Subsequently, the primary die is replaced with a secondary die while the first resin portion is held in the common die, and a second resin is injected into a cavity newly formed using the common die and the secondary die to mold a second resin portion so that a two-color molded article, in which the first resin portion and the second resin portion are integrated with each other, is fabricated.

### SUMMARY

When the front cover described above is molded using the two-color molding, a two-color molding method is generally employed in which a non-light transmitting resin portion is molded using a common die and a primary die, and then, a light transmitting resin portion is molded using the common die and a secondary die. An undercut portion is formed in the non-light transmitting resin portion. Thus, a slider for molding the undercut is mounted in the common die and the non-light transmitting resin portion is molded using the common die and the primary die. Further, the light transmitting resin portion is molded integrally with the previously molded non-light transmitting resin portion using the common die and the secondary die.

However, as will be described below in detail, there has also been suggested a two-color molding method, in which a die not provided with a slider is employed as a common die in order to improve the molding quality of a light transmitting resin portion. In the two-color molding method, first, a light transmitting resin portion is molded using a common die and a primary die, and then, a non-light transmitting resin portion is molded using the common die and a secondary die provided with a slider. According to the two-color molding method, a slide line is not formed in the light transmitting resin portion by the slider, and thus, the appearance quality of the front cover may be improved.

However, when the two-color molding method is employed, there is a problem in that a resin shrinkage or a resin deformation in the light transmitting resin portion molded by the primary die may deteriorate an appearance quality. That is, since the light transmitting resin portion of the front cover is molded in a curved plate shape with a substantially uniform thickness, the light transmitting resin portion is released from the restraint of the primary die when the non-light transmitting resin portion is molded by the secondary die while the molded light transmitting resin portion is held in the common die. Thus, the resin shrinkage or the resin deformation is likely to occur in the peripheral edge of the light transmitting resin portion. When the resin shrinkage or the resin deformation occurs, the peripheral edge of the light transmitting resin portion is peeled off from the cavity face of the common die so that a gap occurs between the light transmitting resin portion and the cavity face. Therefore, when the non-light transmitting resin portion is molded in this state, the molding is performed in a state where the non-light transmitting resin advances into the gap. Accordingly, in an area where a light transmitting resin has to be disposed on the surface, the non-light transmitting resin is exposed, and thus, the molding is performed such that the non-light transmitting resin extends to a part of the light transmitting resin portion. Thus, the appearance quality of the molded front cover is degraded.

An object of the present disclosure is to provide a two-color molding method and a two-color molding die which are capable of suppressing deterioration of an appearance quality which is caused by a resin shrinkage or a resin deformation in a previously molded resin portion. Another object of the present disclosure is to provide a two-color molded article with a high appearance quality, which is molded by the two-color molding method and the two-color molding die of the present disclosure.

According to a first aspect of the present disclosure, a two-color molding method includes: molding a first resin portion by a common die and a primary die; and molding a second resin portion integrally with the first resin portion by the common die and a secondary die. A shape of the first resin portion is maintained by a holder provided in the secondary die when the second resin portion is molded. In the first aspect, when the second resin portion is molded, a part of the first resin portion may be pressed by the holder against a cavity face of the common die to maintain the shape of the first resin portion.

According to a second aspect of the present disclosure, a two-color molding die includes: a common die and a primary die configured to mold a first resin portion; and a secondary die configured to mold a second resin portion in the common die. The secondary die is provided with a holder configured to press the first resin portion against the common die to maintain a shape of the first resin portion. In the second aspect, the holder may be constituted by a projection erected on a cavity face of the secondary die.

According to a third aspect of the present disclosure, a two-color molded article includes: a first resin portion; and a second resin portion molded integrally with the first resin portion. A through hole is present in the second resin portion in a region along a periphery of the first resin portion to extend from a surface of the second resin portion to a surface of the first resin portion. For example, the two-color molded article is a front cover of a vehicular lamp, the first resin portion is constituted by a light transmitting resin portion, the second resin portion is constituted by a non-light transmitting resin portion, and the second resin portion is molded to be stacked on a peripheral edge of the first resin portion. Further, the second resin portion is configured as a mounting unit for attaching the front cover to a lamp body, and an undercut portion is present in a part of the second resin portion.

According to the first aspect of the present disclosure, the shape of the first resin portion is maintained by the holder provided in the secondary die when the second resin portion is molded. Thus, even when the molded first resin portion is deformed, the shape of the first resin portion is maintained by the holder. Accordingly, deterioration of an appearance quality of the two-color molded article which is caused by the shape deformation of the first resin portion may be suppressed.

According to the second aspect of the present disclosure, the secondary die is provided with the holder configured to press the first resin portion against the common die to maintain the shape of the first resin portion. Thus, after the first resin portion is molded, the shape of the first resin portion is maintained by the holder while the second resin portion is molded by the secondary die. Accordingly, deterioration of an appearance quality of the two-color molded article which is caused by the shape deformation of the first resin portion may be suppressed.

According to the third aspect of the present disclosure, in the two-color molded article in which the first resin portion and the second resin portion are molded integrally with each other, the through hole is present in the second resin portion to extend to the surface of the first resin portion. Thus, when the holder for forming the through hole is provided in the secondary die, the deformation of the first resin portion may be suppressed by the holder, and as a result, deterioration of an appearance quality of the two-color molded article may be suppressed. Also, it is possible to put an indication such as, for example, a character, a symbol, or a mark on the two-color molded article by using the first resin portion exposed at the through hole.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an external perspective view of a part of a vehicle equipped with a headlamp according to the present disclosure.

FIG. 2 is an enlarged cross-sectional view taken along line II-II in FIG. 1.

FIGS. 3A and 3B are schematic cross-sectional views illustrating a first molding method of a two-color molding method.

FIGS. 4A and 4B are schematic cross-sectional views illustrating a second molding method of a two-color molding method.

FIGS. 5A to 5C are a cross-sectional view of a part of a die for explaining problems in the second molding method, a cross-sectional view of a part of a molded front cover, and a front view of the part of the molded front cover, respectively.

FIGS. 6A to 6C are a cross-sectional view of a part of a die for explaining the structure and operation of a holder of the present disclosure, a cross-sectional view of a part of a molded front cover, and a front view of the part of the molded front cover, respectively.

FIGS. 7A to 7E are schematic perspective views illustrating different types of holders, respectively.

FIGS. 8A and 8B are a schematic perspective view illustrating another type of a holder and a perspective view illustrating a part of a molded front cover, respectively.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

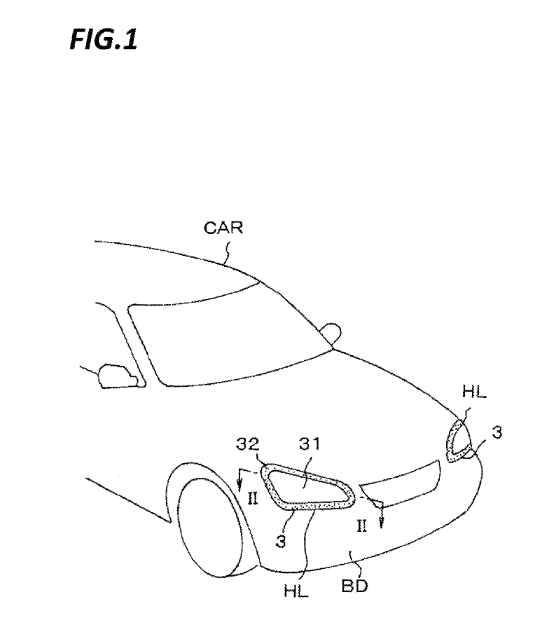

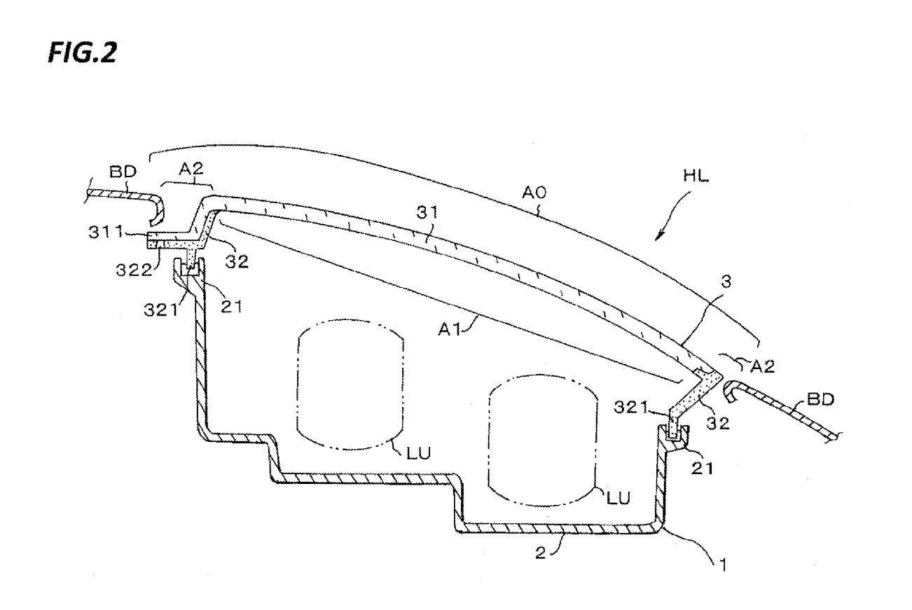

Hereinafter, an exemplary embodiment of the present disclosure will be described with reference to the accompanying drawings. FIG. 1 is an external perspective view of an exemplary embodiment, in which a two-color molded article according to the present disclosure is employed in a front cover of a headlamp disposed on a front portion of a vehicle CAR. Left and right headlamps HL are disposed on the front portion of a body BD of the vehicle CAR. FIG. 2 is an enlarged cross-sectional view taken along line II-II of the right headlamp HL in FIG. 1 in which illustration of some components is emitted. A lamp housing 1 accommodates a lamp unit LU configured to emit light to be controlled according to a required light distribution, and includes a container-type lamp body 2 having a front opening and a front cover 3 attached to the front opening of the lamp body 2. The front cover 3 is manufactured by a two-color molding method of the present disclosure.

In FIG. 2, the front cover 3 includes a light transmitting resin portion 31 and a black resin portion 32 which are integrally molded with each other. The light transmitting resin portion 31 is molded of a colorless transparent light transmitting resin, and the black resin portion 32 is molded of a black resin to be stacked in the thickness direction on the peripheral edge of the light transmitting resin portion 31. The light transmitting resin portion 31 is formed in a plate shape with a substantially uniform thickness, which is curved convexly toward the front side of the lamp to be continued to a front curved surface of the body BD of the vehicle CAR. The light transmitting resin portion 31 is configured to transmit the light emitted from the lamp unit LU to irradiate the light to the front area of the vehicle CAR. The light transmitting resin portion 31 corresponds to a first resin portion of the present disclosure.

The black resin portion 32 is formed in a frame shape which extends along a part of the light transmitting resin portion 31, that is, a flange portion 311 formed in the peripheral edge of the light transmitting resin portion 31 (hereinafter, referred to as a peripheral flange portion). The black resin portion 32 corresponds to a second resin portion of the present disclosure. The black resin portion 32 is configured to function as a mounting unit for attaching the front cover 3 to the lamp body 2. The black resin portion 32 is formed to extend from the end face of the peripheral flange portion 311 of the light transmitting resin portion 31 toward the rear side (the lamp rear side), or to extend to a region which covers the rear surface (the surface directed to the lamp rear side) of the peripheral flange portion 311. A mounting portion 321 in a rib shape that extends to protrude toward the lamp rear side is molded integrally with the black resin portion 32. The mounting portion 321 is bonded to an opening edge 21 of the front opening of the lamp body 2 to constitute the lamp housing 1. In the bonding, adhesion using an adhesive or lase welding is used.

The black resin portion 32 also has a function of defining an effective portion A1 in the light transmitting resin portion 31. Through the effective portion A1, the light emitted from the lamp unit LU may be effectively transmitted to be irradiated to the front area of the vehicle. That is, the black resin portion 32 forms a shielding portion (ineffective portion) A2 which suppresses the peripheral edge region of the lamp housing 1 from being exposed to the outside of the headlamp HL. Here, a rear end 32r of the black resin portion 32 for attaching the front cover 3 to the lamp body 2 is suppressed from being exposed to the outside.

The headlamp HL having the front cover 3 is disposed on the front side of the body BD of the vehicle CAR as described above, and the front cover 3 is exposed through the opening of the body BD in the disposed state. Here, among the light transmitting resin portion 31 and the black resin portion 32 of the front cover 3, a region which is exposed to the outside without being covered by the body BD is configured as a design portion A0 of the front cover 3. In this example, a region including the effective portion A1 and a part of the inner periphery side region of the ineffective portion A2 around the effective portion A1 is configured as the design portion A0. When the design portion A0 is observed from the front side, the effective portion A1 is observed as a clear transparent surface, and the ineffective portion A2 around the effective portion A1 is observed as a clear black surface because the black resin portion 32 is observed through the light transmitting resin portion 31. Accordingly, the appearance quality of the front cover 3 or the headlamp IIL may be improved. In the front cover 3, the periphery of the headlamp design surface is bordered in the dark color, and thus, the design surface has a clear appearance (eyeline effect). The structure (such as a fastening portion between a lens and a body) within the lamp is not seen. As a functional effect, light leakage prevention from the side portion of the resin cover is also achieved.

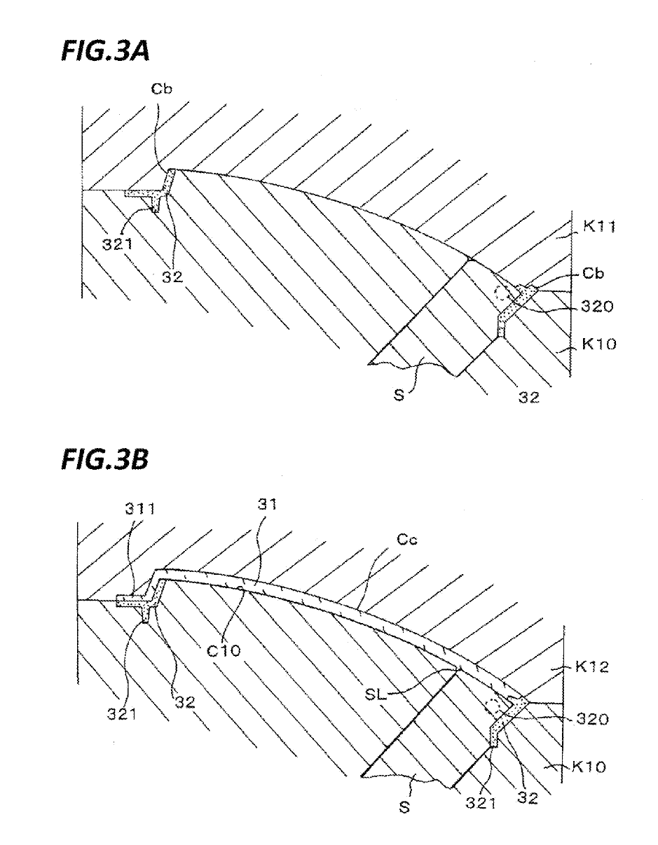

Hereinafter, a two-color molding method of the front cover will be described. FIGS. 3A and 3B are schematic cross-sectional views of a die for explaining a first molding method. First, as illustrated in FIG. 3A, a required cavity Cb is configured by a common die K10 and a primary die K11, and a black resin is injected into the cavity Cb to mold a black resin portion 32. Subsequently, as illustrated in FIG. 3B, while the molded black resin portion 32 remains in the common die K10, the primary die K11 is replaced with a secondary die K12. A new cavity Cc is configured by the common die K10 and the secondary die K12, and a light transmitting resin is injected into the cavity Cc to mold a light transmitting resin portion 31. Accordingly, the front cover 3 illustrated in FIG. 2, in which the light transmitting resin portion 31 and the black resin portion 32 are integrated with each other, is molded. A slider S is provided in the common die K10, and is used to mold an undercut portion 320 (indicated by a dashed circle) which occurs in the black resin portion 32.

In the first molding method, the slider S provided in the common die K10 is exposed in the cavity Cc configured by the common die L10 and the secondary die K12. Thus, when the light transmitting resin portion 31 is molded, a small width gap (slit) occurring in the boundary between the slider S and the common die K10 is transferred to the rear surface of the light transmitting resin portion 31 to form a so-called slide line SL. The slide line SL is observed from the front side of the light transmitting resin portion 31 because the light transmitting resin portion 31 is transparent. Thus, the appearance quality of the front cover 3 or the headlamp HL may be deteriorated.

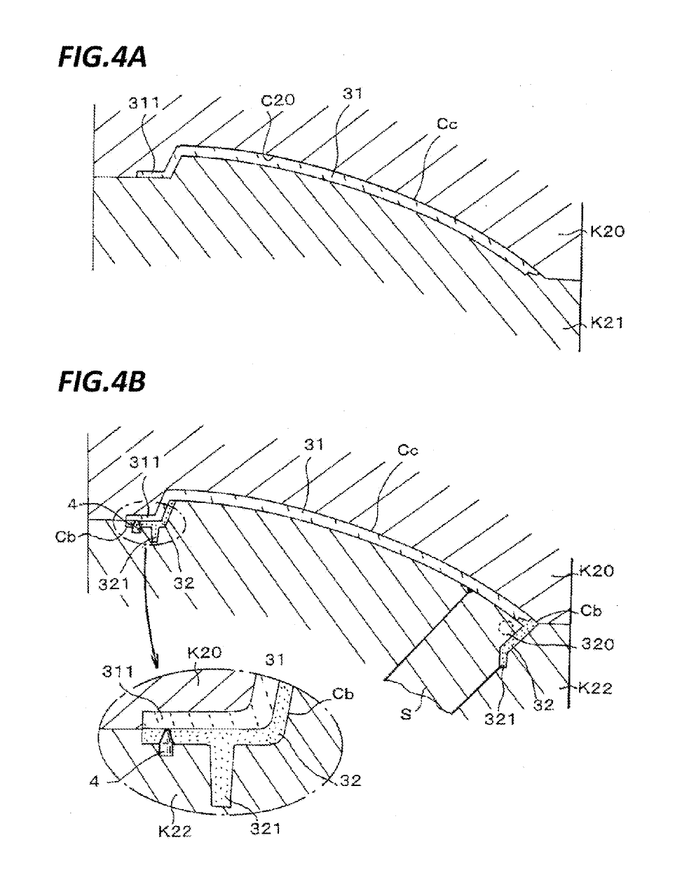

FIGS. 4A and 4B are cross-sectional views for explaining a second molding method, which are similar to FIGS. 3A and 3B. In the second molding method, first, as illustrated in FIG. 4A, a die for molding the front side of a light transmitting resin portion 31 is set as a common die K20, and a cavity Cc is configured by the common die K20 and a primary die K21 to mold a light transmitting resin portion 31. Subsequently, as illustrated in FIG. 4B, the primary die K21 is replaced with a secondary die K22 to configure a cavity Cb, and a black resin portion 32 is molded. When a slider S is provided in the secondary die K22, an undercut portion 320 which occurs in the black resin portion 32 may be molded.

When the second molding method is used for two-color molding of a front cover 3, a slide line is not formed in the light transmitting resin portion 31 because a slider is not present in the primary die K21 used for molding the light transmitting resin portion 31. Therefore, deterioration of the appearance quality by the slide line SL as in the first molding method may be suppressed.

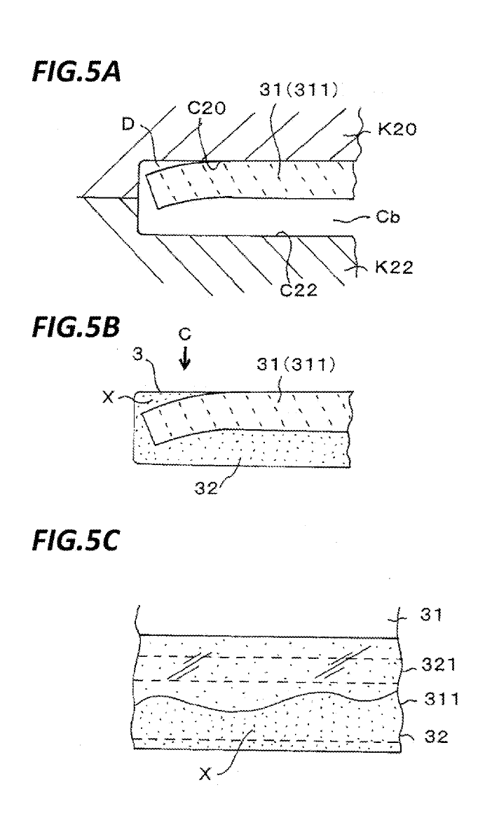

However, in the second molding method, when the black resin portion is molded by the secondary die K22 after the light transmitting resin portion 31 is molded by the common die K20 and the primary die K21 as described above, as illustrated in FIG. 5A (an enlarged view of a peripheral flange portion 311 of the light transmitting resin portion 31), a resin shrinkage or a resin deformation occurs due to a temperature change or a time-dependent change between the moldings of the black resin portion and the light transmitting resin portion. In particular, a cavity face C20 (here and hereinafter, an inner surface of a die which configures the cavity) of the common die K20 has a concave shape, and thus, is poor in molded resin retention capability as compared to a cavity face C10 of the common die K10 (see, e.g., FIG. 3B) which has a convex shape. Therefore, the shrinkage or deformation becomes significant in the peripheral flange portion 311 which is a free end of the light transmitting resin portion 31 so that the peripheral flange portion 311 is released from the state where it is in close contact with the cavity face C20 of the common die K20 and thus, a gap D occurs between the cavity face and the front surface of the peripheral flange portion 311.

When the black resin portion 32 is molded in this state, a part of the black resin advances into the gap. Then, as illustrated in FIG. 5B and FIG. 5C, a part of the black resin portion 32 is molded as an “overflowed part” X on the front surface of the peripheral flange portion 311 of the light transmitting resin portion 31. FIG. 5B is a cross-sectional view of the molded front cover 3, and FIG. 5C is a front view taken in the direction indicated by arrow C in FIG. 5B. When the part of the black resin portion 32, as the “overflowed part” X advances to the design portion A0 of the light transmitting resin portion 31 illustrated in FIG. 2, the black resin portion 32 is observed from the front surface side of the light transmitting resin portion 31, and the appearance of the clear black surface described above is impaired. Thus, the appearance quality of the front cover 3 or the headlamp HL is degraded.

In the first molding method illustrated in FIGS. 3A and 3B, since the molded black resin portion 32 has a smaller area and a smaller volume than the light transmitting resin portion 31, the extent of the resin shrinkage or resin deformation is small after the black resin portion 32 is molded. Even if a gap occurs between the black resin portion 32 and the cavity face due to the resin shrinkage or the resin deformation, the deterioration of the appearance quality is less problematic because the light transmitting resin portion 31 advancing to the gap is transparent.

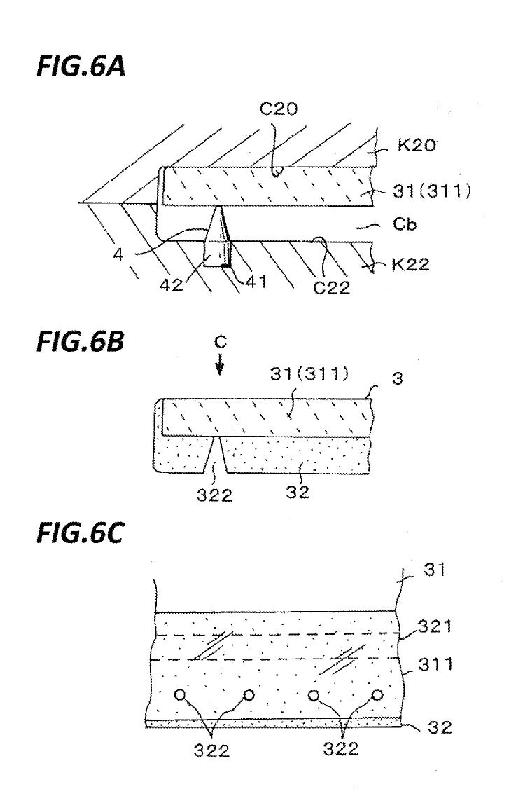

Therefore, in the present disclosure, the second molding method in which the slide line SL does not occur in the light transmitting resin portion 31 is employed, and then occurrence of a gap is suppressed between the light transmitting resin portion 31 and the cavity face C20 of the common die K20 so that occurrence of the “overflowed part” described above is suppressed. In order to achieve this, as partially illustrated in FIG. 4B in an enlarged scale, and further in FIG. 6A in an enlarged scale, a holder 4 is formed on the cavity face C22 of the secondary die K22.

That is, as illustrated in FIGS. 4A and 4B, after the light transmitting resin portion 31 is molded by the common die K20 and the primary die K21, the cavity Cb for molding the black resin portion 32 is configured by the common die K20 and the secondary die K22. The holder 4 is formed integrally with the cavity face C22 of the secondary die K22. The tip end of the holder 4 is abutted on the surface (herein, the rear surface) of the light transmitting resin portion 31 held by the cavity face C20 of the common die K20 so that the holder 4 presses and holds the light transmitting resin portion 31 against the cavity face C20 of the common die K20 by the pressing force caused by the abutment.

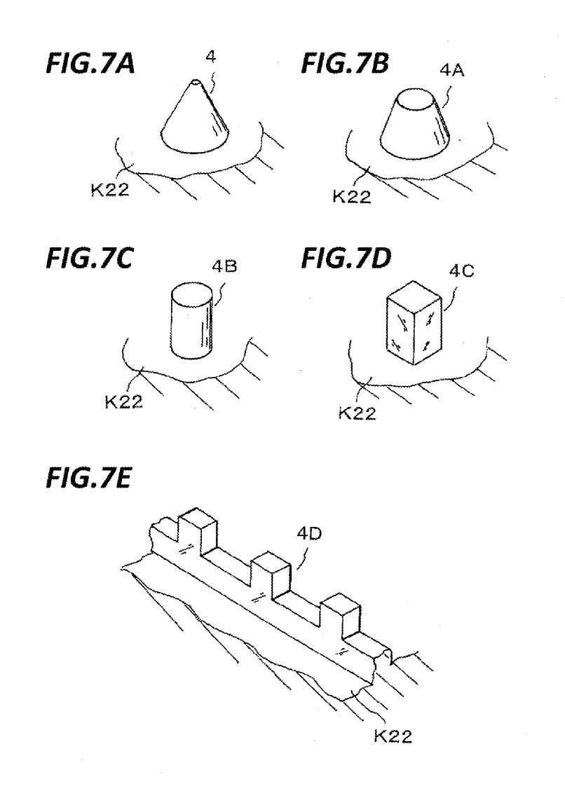

The holder is formed as a pin-like projection provided to be erected on the cavity face C22 of the secondary die K22, and is arranged at a location along the peripheral edge of the light transmitting resin portion 31 in which a resin shrinkage or a resin deformation is likely to occur, that is, in a region of the peripheral flange portion 311 of the light transmitting resin portion 31. Although only one holder 4 is illustrated in FIGS. 4B and 6A, the holders are configured by a plurality of projections which are arranged at predetermined intervals along the longitudinal direction of the peripheral flange portion 311, that is, in the direction along the peripheral edge of the light transmitting resin portion 31. Herein, a projection constituting the holder 4 is formed in a conical shape illustrated in FIG. 7A. In the example of FIG. 6A, a recess 41 is formed in the cavity face C22 of the secondary die K22, and a base end of a conical projection 42 formed as a separate member is press-fitted into the recess 41.

Even if the resin shrinkage occurs in the peripheral flange portion 311 of the light transmitting resin portion 31 until the black resin portion is molded in the secondary die K22 after the light transmitting resin portion 31 is molded as illustrated in FIG. 6B, since the holder 4 is provided, the holder 4 presses the peripheral flange portion 311 against the cavity face C20 of the common die K20 to maintain the shape of the light transmitting resin portion 31. Thus, the gap D illustrated in FIG. 5A does not occur between at least the cavity face C20 of the common die K20 and the front surface of the light transmitting resin portion 31.

Accordingly, when the black resin is molded, the black resin is suppressed from advancing to the front surface side of the peripheral flange portion 311, and occurrence of the “overflowed part” X, which is a part of the black resin portion is molded on the front surface side of the peripheral flange portion 311 as illustrated in FIG. 5C, is suppressed. Accordingly, the deterioration of the appearance quality of the front cover 3 or the headlamp HL due to the “overflowed part” is suppressed. That is, the peripheral flange portion 311 is formed as the ineffective portion A2 by the black resin portion 32 stacked on the rear surface, while the exposed state of the front surface of the light transmitting resin portion 31, as it is, is maintained on the front surface of the peripheral flange portion 311. Thus, the clarity is obtained due to light reflection from the front surface to the same extent as the effective portion A1, thereby securing a high appearance quality.

In the front cover 3 obtained through two-color molding as described above, in the design portion A0 illustrated in FIG. 2, the central region of the light transmitting resin portion 31 whose periphery is defined by the black resin portion 32 is configured as the effective portion A1 having a light transmitting property. Thus, light emitted from the lamp unit LU is transmitted through the central region to illuminate the front area of the vehicle. On the peripheral edge of the design portion A0, the inner portion of the headlamp HL is suppressed from being exposed due to the ineffective portion A2 constituted by the black resin portion 32 formed on the rear surface of the peripheral flange portion 311 of the light transmitting resin portion 31. In the front cover 3, the periphery of the design surface of the headlamp is bordered in the dark color, and thus, the design surface has a clear appearance (eyeline effect). The structure (such as a fastening portion between a lens and a body) within the lamp is not seen. As a functional effect, light leakage prevention from the side surface of a resin cover may also be obtained.

In the front cover 3 obtained through two-color molding, as can be seen from FIG. 6B, a through hole 322 is formed in the black resin portion 32 molded on the rear surface of the peripheral flange portion 311 of the light transmitting resin portion 31, at a site where a projection was present as the holder 4. That is, the black resin portion 32 is not molded in the portion on which the holder 4 was abutted. Thus, the through hole 322 is formed at the site described above through the black resin portion 32 in the thickness direction so that the rear surface of the light transmitting resin portion 31 is exposed through the through hole 322.

In regard to the through hole 322, as illustrated in FIG. 6C, which is a front view taken in a direction indicated by arrow C in FIG. 6B, when the front cover 3 is illuminated from the front side, a plurality of point-like light transmitting portions is observed due to the through holes 322 in the black resin portion 32 because the through holes 322 corresponding to a plurality of holders 4 are formed to be arranged along the peripheral flange portion 311. The light transmitting portions have small dimensions, and thus, are hardly visually recognized with naked eyes, thereby having little influence on the appearance quality of the front cover 3. When the point-like light transmitting portions are set to be positioned in the peripheral flange portion 311 out of the design portion A0, that is, to be covered by the body BD of the vehicle, the deterioration of the appearance quality due to the point-like light transmitting portions may be suppressed.

Here, the holder 4 is configured so as to press the front surface of the light transmitting resin portion 31 against the cavity face C20 of the common die K20 to maintain the shape of the light transmitting resin portion 31 so that a gap does not occur between the light transmitting resin portion 31 and the cavity face C20. Thus, in forming the holder 4, it is most important to form the holder 4 such that the tip end of the holder 4 is securely abutted on the rear surface of the light transmitting resin portion 31. Accordingly, in order to avoid that the tip end of the holder 4 is not abutted on the rear surface of the light transmitting resin portion 31 due to a manufacturing error of the holder 4, the tip end of the holder 4 may be formed in a slightly longer length to cut into the rear surface of the light transmitting resin portion 31. Even if such cutting occurs, the appearance quality is not problematic because the cut portion becomes the point-like light transmitting portion as described above after molding, and the black resin portion 32 is formed around the cut portion.

The shape of the holder 4 is not limited to the configuration of the exemplary embodiment as long as the holder 4 can be abutted on the rear surface of the light transmitting resin portion 31 to press the light transmitting resin portion 31 against the cavity face C20 of the common die K20. For example, the holder 4 may be a projection formed in a truncated cone shape 4A, a cylindrical shape 4B, or a prismatic shape 4C illustrated in FIGS. 7B, 7C, and 7D, or a projection formed in a pyramidal shape or a truncated pyramid shape (not illustrated). However, since the through hole 322 is formed in the black resin portion 32 by the holder 4, the holder 4 may be formed in a shape having a small contact area with the light transmitting resin portion 31, such as a spindle shape, in order to reduce the size of the light transmitting portion formed by the through hole 322 as much as possible.

The holder 4 may be a vertical wall 4D extending by a predetermined length along the peripheral edge of the light transmitting resin portion, as illustrated in FIG. 7E. However, as in the front cover 3 according to the exemplary embodiment, when the black resin portion 32 is formed over substantially the entire area of the peripheral flange portion 311 of the light transmitting resin portion 31, it is required to provide notches at a part or a plurality of locations of the vertical wall 4D to penetrate the vertical wall 4D in the plate thickness direction so that the black resin flows into the end portion region of the peripheral flange portion 311.

The holder 4 may be formed integrally with the secondary die K22 rather than being formed as a separate member from the secondary die K22. That is, when the cavity of the secondary die K22 is processed, projections may be formed as holders 4 at once in a part or a plurality of locations of the cavity face C22. Although the number of steps of processing the die is increased, it is advantageous in reducing the number of components.

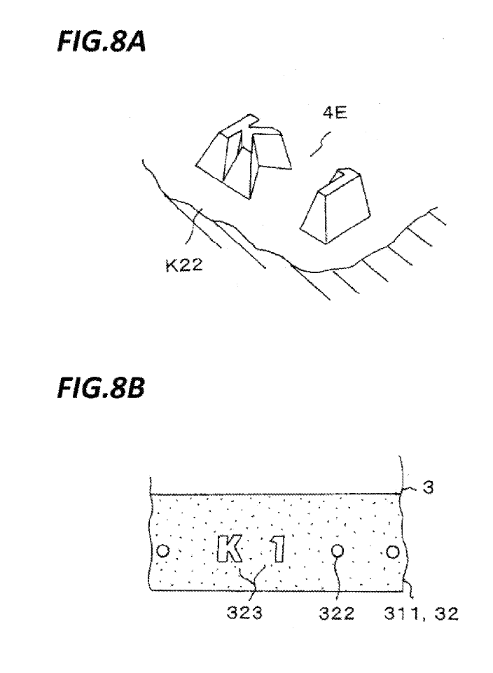

Since the light transmitting portions occur by the through holes 322 formed by the holders 4 as described above, it is possible to actively use the fact that the light transmitting portions are observed by illuminating the front cover 3. For example, as illustrated in FIG. 8A, some holders 4E among the plurality of holders are formed as characters, symbols, or marks in planar shapes (when the holders are viewed from the tip side). Here, characters of “K” and “1” are formed on the tip end surfaces of the holders 4E. When the holders 4E are abutted on the rear surface of the peripheral flange portion 311 of the light transmitting resin portion 31 as described above while the shape of the light transmitting resin portion 31 is maintained and the black resin portion 32 is molded, through holes 323 having the character shapes of “K” and “1” are formed in the black resin portion 32 as illustrated in FIG. 8B on the peripheral flange portion 311 of the molded front cover 3. Accordingly, when the front cover 3 is illuminated, the characters of “K” and “1” observed as the light transmitting portions due to the through holes 323 may be used as identification marks for identifying the front cover 3.

The two-color molded article according to the present disclosure is not limited to the front cover of the headlamp, and is applicable to any resin molded article molded by the primary molding step and the secondary molding step. For example, the two-color molded article is also applicable in a case where a front cover (the front side cover of a lamp) of an indicator lamp including a rear lamp of a vehicle is molded through two-color molding. Descriptions have been made on an example in which the first resin portion is molded as the light transmitting resin portion, and the second resin portion is molded as the black resin portion in the exemplary embodiment described above. However, it is obvious that the first resin portion and the second resin portion are not limited to the resin in the exemplary embodiment. That is, the present disclosure is applicable in a case where, when the first resin portion and the second resin portion are sequentially molded through two-color molding and a part of the second resin portion advances to the front surface of the first resin portion, the appearance quality of the two-color molded article may be deteriorated, for example, even in a case of two-color molding in which the first resin portion is a light color resin, and the second resin portion is a dark color resin.

The present disclosure may be employed in a two-color molding technology of sequentially and integrally molding different resins.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A two-color molding method comprising:
molding a first resin portion by a common die and a primary die; and
molding a second resin portion integrally with the first resin portion by the common die and a secondary die,
wherein a shape of the first resin portion is maintained by a holder provided in the secondary die when the second resin portion is molded.

2. The two-color molding method of claim 1, wherein, when the second resin portion is molded, a part of the first resin portion is pressed by the holder against a cavity face of the common die to maintain the shape of the first resin portion.

3. A two-color molding die comprising:
a common die and a primary die configured to mold a first resin portion; and
a secondary die configured to mold a second resin portion in the common die,
wherein the secondary die is provided with a holder configured to press the first resin portion against the common die to maintain a shape of the first resin portion.

4. The two-color molding die of claim 3, wherein the holder is constituted by a projection erected on a cavity face of the secondary die.

5. A two-color molded article comprising:
a first resin portion; and
a second resin portion molded integrally with the first resin portion,
wherein a through hole is present in the second resin portion in a region along a periphery of the first resin portion to extend from a surface of the second resin portion to a surface of the first resin portion.

6. The two-color molded article of claim 5, wherein the two-color molded article is a front cover of a vehicular lamp, the first resin portion is constituted by a light transmitting resin portion, the second resin portion is constituted by a non-light transmitting resin portion, and the second resin portion is molded to be stacked on a peripheral edge of the first resin portion.

7. The two-color molded article of claim 6, wherein the second resin portion is configured as a mounting unit for attaching the front cover to a lamp body, and an undercut portion is present in a part of the second resin portion.
